(19) United States
(12) Patent Application Publication
(10) Pub. No.: US 2018/0193985 A1
(43) Pub. Date: Jul. 12, 2018

(54) SOCKET FOR SPARKPLUG

(71) Applicant: Chuang Lion Industry Co., Ltd, Taichung (TW)

(72) Inventor: Nian-Hao Liao, Taichung (TW)

(21) Appl. No.: 15/403,072

(22) Filed: Jan. 10, 2017

(51) Int. Cl. B25B 13/48; B25B 23/12

(52) U.S. Cl. CPC B25B 13/483; B25B 23/12

(57) ABSTRACT

A socket assembly includes a socket, a lining and an annular magnet. The socket includes a hexagonal bore, six internal facets around the hexagonal bore, and two apertures in communication with the hexagonal bore. The lining includes a hexagonal block, two strips extending from the hexagonal block, and two bosses each formed on a corresponding one of the strips. The hexagonal block is inserted in the hexagonal bore, and includes a cavity, six external facets in contact with the internal facets of the socket, and six ridges each formed between two adjacent ones of the external facets. The annular magnet is inserted in the cavity. Each of the bosses is inserted in a corresponding one of the apertures. The annular magnet is squeezed tighter by the lining since the ridges are pressed tighter against an internal face of the socket as the lining is inserted deeper in the hexagonal bore.

### BACKGROUND OF INVENTION

### 1. Field of Invention

The present invention relates to a tool and, more particularly, to a socket for a plug.

### 2. Related Prior Art

A socket can be used to drive a hexagonal section of a sparkplug. The socket includes a square bore in an end and a hexagonal bore in an opposite end. The square bore is used to receive a square tongue of a handle. The hexagonal bore is used to receive a hexagonal section of a sparkplug. The handle is operable to rotate the sparkplug via the socket. However, the sparkplug could easily fall from the socket after the sparkplug is disconnected from an engine because the socket does not include any magnet. Moreover, a new sparkplug could easily fall from the socket before the new sparkplug is connected to the engine. Hence, it requires two hands to detach the sparkplug to the engine or detached the sparkplug from the engine, and this is troublesome.

As disclosed in Taiwanese Patent M524767, a magnet 3 is inserted in a lining 2 that is in turn inserted in a socket 1. The lining 2 includes a constant section 20 and an expansive section 21. The expansive section 21 extends in a radial manner from the constant section 20 as the former axially extends from the latter. The constant section 20 includes cutouts 201 to improve flexibility thereof. The expansive section 21 includes grooves 210 in the periphery to improve flexibility thereof. The expansive section 21 squeezes the magnet 3 tighter as the former is inserted deeper in the socket 1. However, it requires a complicated process and hence involves a high cost to provide the lining 2 with the cutouts 201 in the constant section 20 and the grooves 210 in the expansive section 21.

The present invention is therefore intended to obviate or at least alleviate the problems encountered in prior art.

### SUMMARY OF INVENTION

It is the primary objective of the present invention to provide an inexpensive and reliable socket assembly for a sparkplug.

To achieve the foregoing objective, the socket assembly includes a socket, a lining and an annular magnet. The socket includes a hexagonal bore, six internal facets around the hexagonal bore, and two apertures in communication with the hexagonal bore. The lining includes a hexagonal block, two strips extending from the hexagonal block, and two bosses each formed on a corresponding one of the strips. The hexagonal block is inserted in the hexagonal bore, and includes a cavity, six external facets in contact with the internal facets of the socket, and six ridges each formed between two adjacent ones of the external facets. The annular magnet is inserted in the cavity. Each of the bosses is inserted in a corresponding one of the apertures. The annular magnet is squeezed tighter by the lining since the ridges are pressed tighter against an internal face of the socket as the lining is inserted deeper in the hexagonal bore.

In another aspect, each of the ridges includes a front end and a rear end, and rises higher from the hexagonal block in a radial manner while extending to the rear end from the front end. The front end of each of the ridges is inserted in the hexagonal bore before the rear end.

In another aspect, the strips extend from a front end of the hexagonal block so that the strips are inserted in the hexagonal bore before the hexagonal block.

In an alternative aspect, the strips extend from a rear end of the hexagonal block so that the strips are inserted in the hexagonal bore after the hexagonal block.

In another aspect, one of the strips includes an external face in a same plane with one of the facets, and the other strip includes an external face in a same plane with an opposite one of the facets.

In another aspect, the socket includes six grooves each extending between two adjacent ones of the internal facets. Each of the ridges is inserted in a corresponding one of the grooves.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a socket assembly that includes a socket and a lining according to the first embodiment of the present invention;

FIG. 2 is a cross-sectional view of the lining shown in FIG. 1;

FIG. 3 is a cross-sectional view of the socket assembly shown in FIG. 1;

FIG. 4 is another cross-sectional view of the socket assembly shown in FIG. 1;

FIG. 5 is an exploded view of a socket assembly that includes a socket and a lining according to the second embodiment of the present invention;

FIG. 6 is a cross-sectional view of the lining shown in FIG. 5; and

FIG. 7 is a cross-sectional view of the socket assembly shown in FIG. 5.

### DETAILED DESCRIPTION OF EMBODIMENTS

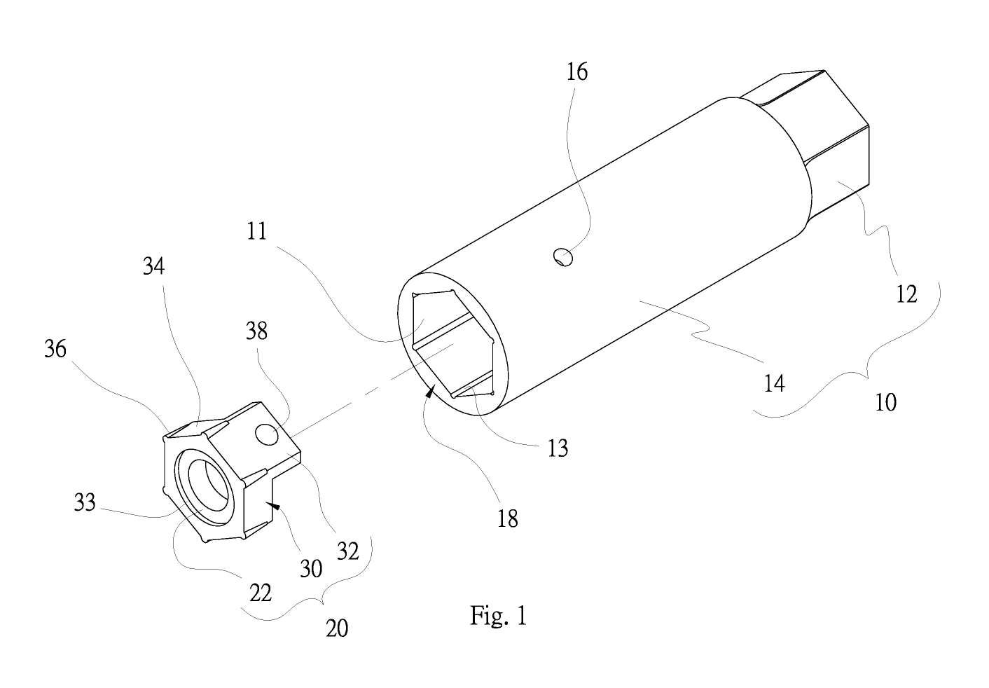

Referring to FIGS. 1 through 4, a socket assembly includes a socket 10, a lining 20 and an annular magnet 22 according to a first embodiment of the present invention. The socket 10 receives the lining 20 which in turn receives the magnet 22.

The socket 10 includes two sections 12 and 14 that are made in one piece. The sections 12 and 14 are located at opposite ends of the socket 10. The section 12 preferably includes a hexagonal external face. However, the section 12 can include a square external face in another embodiment. Hence, the section 12 can be inserted in corresponding bore made in another socket for example. The section 12 can includes a square internal face so that the section can receive a square tongue of a handle for example

The section 14 is made with two apertures 16 and a hexagonal bore 18. The hexagonal bore 18 is axially made in the section 14 so that the section 14 includes six facets 11 around the hexagonal bore 18. The hexagonal bore 18 can be any other proper polygonal bore. The section 14 further includes six grooves 13 each is made between two adjacent ones of the facets 11. The apertures 16 are in communication with the hexagonal bore 18. One of the apertures 16 includes an open end in one of the facets 11 while the other aperture 16 includes an open end in an opposite one of the facets 11.

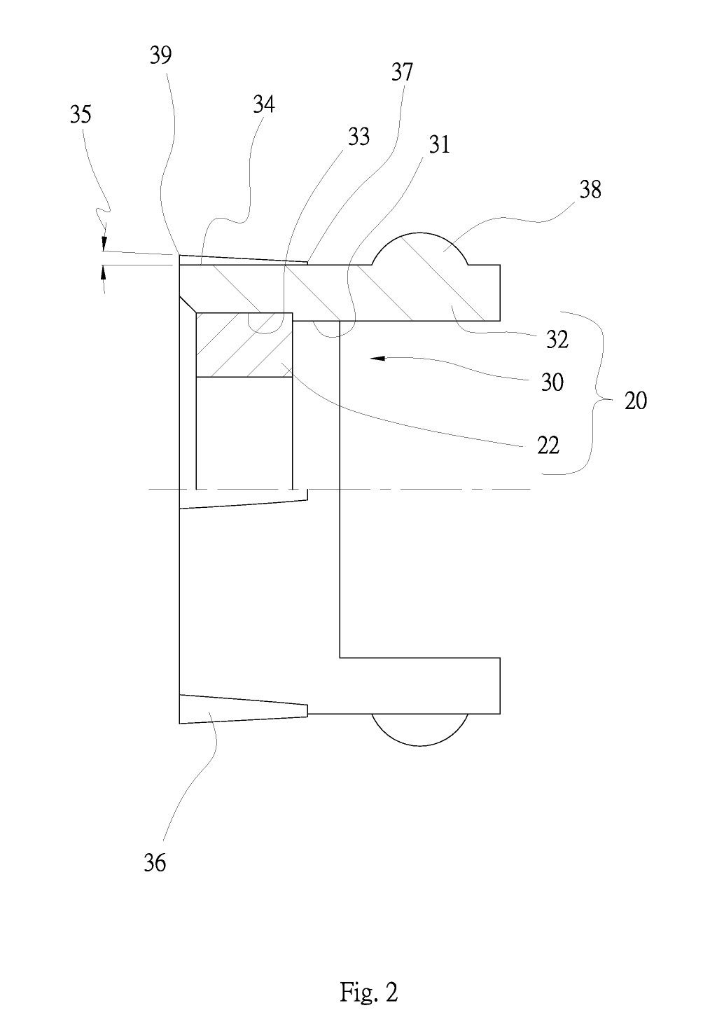

Referring to FIGS. 1 and 2, the lining 20 includes a hexagonal block 30, two strips 32 and two bosses 38. The hexagonal block 30, the strips 32 and the bosses 38 are made in one piece.

The hexagonal block 30 includes a space 31 and a cavity 33. Both of the space 31 and the cavity 33 are axially made in the hexagonal block 30. The space 31 is in communication with the cavity 33. The hexagonal block 30 further includes six facets 34 and six ridges 36. The facets 34 and the six ridges 36 are formed on an external face of the hexagonal block 30. Each of the ridges 36 extends between two adjacent ones of the facets 34. Each of the ridges 36 includes two ends 37 and 39. Each of the ridges 36 gets higher as it extends to the end 39 from the end 37 so that there is an angle 35 between and an edge (not numbered) between the corresponding adjacent facets 34.

The strips 32 longitudinally extend from a front end of the hexagonal block 30. One of the strips 32 includes an external face that extends in a same plane with one of the facets 34. The other strip 32 includes an external face that extends in a same plane with an opposite one of the facets 34.

Each of the bosses 38 is made on the external face of a corresponding one of the strips 32. Each of the bosses 38 includes a dome and can be a semi-sphere.

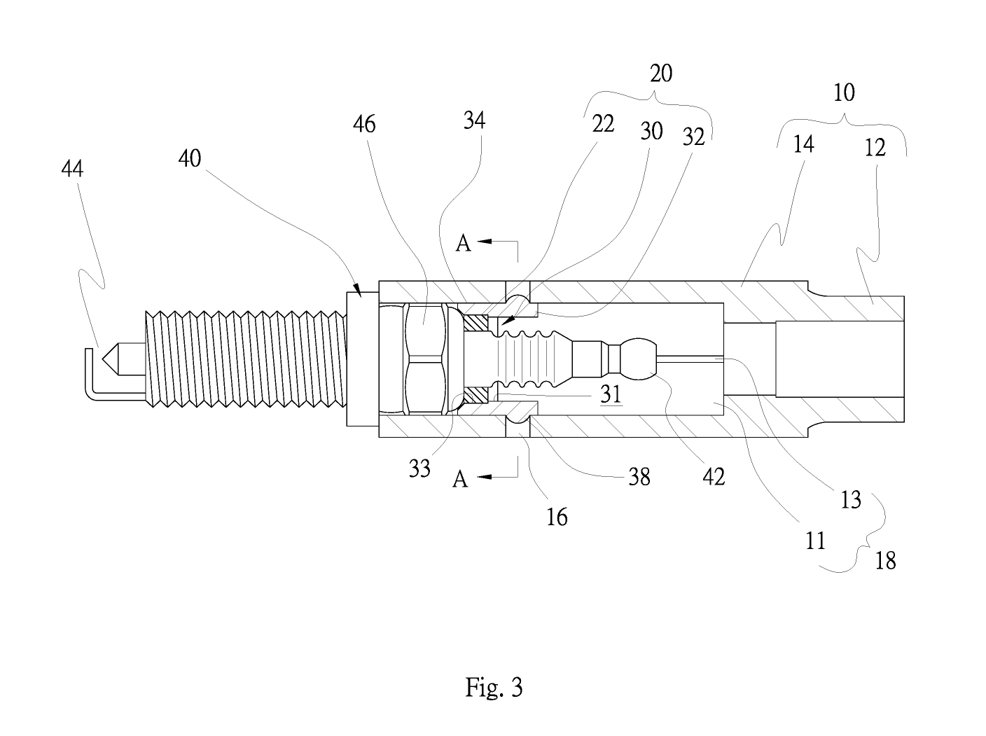

Referring to FIG. 3, the annular magnet 22 is inserted in the cavity 33 of the hexagonal block 30. The strips 32 of the lining 20 are inserted in the hexagonal bore 18 of the section 14 before the hexagonal block 30. The end 37 of each of the ridges 36 is located deeper in the hexagonal bore 18 than the end 39. In an axial sense of direction of the lining 20, the space 31 is located between the cavity 33 and the bosses 38.

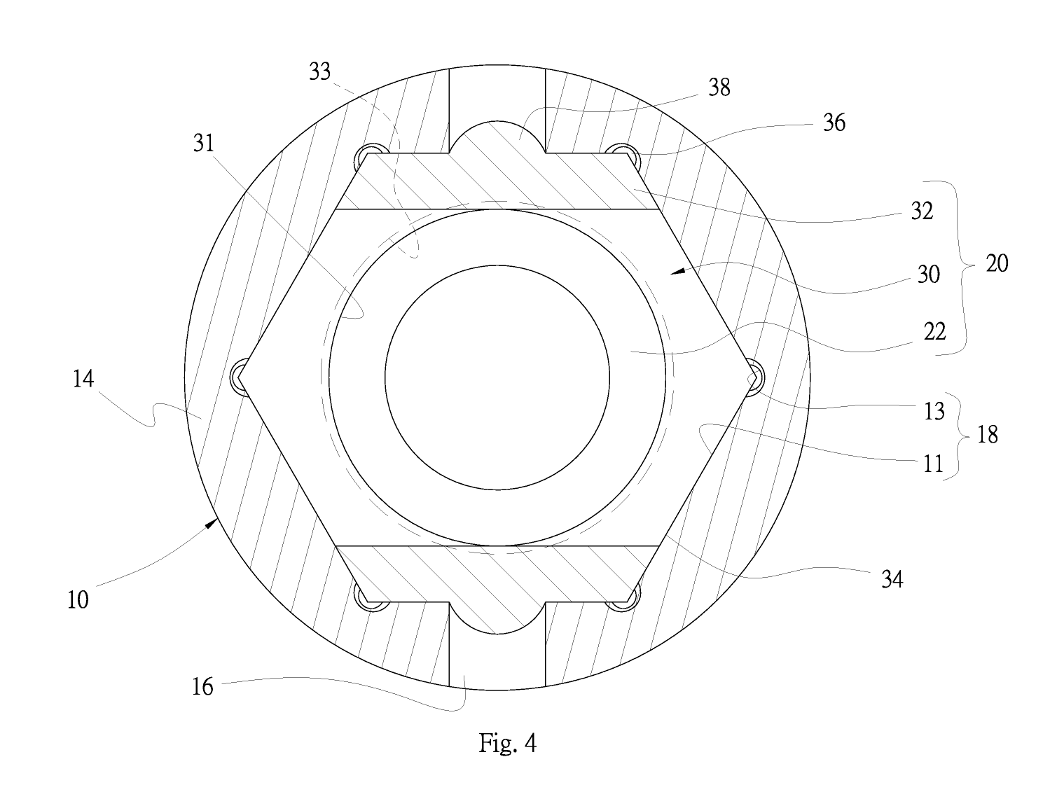

Referring to FIG. 4, each of the facets 34 of the lining 20 is in contact with a corresponding one of the facets 11 of the socket 10. Each of the ridges 36 of the lining 20 is inserted in a corresponding one of the grooves 13 of the socket 10. The ridges 36 are pressed tighter against the internal face of the section 14 to cause the hexagonal block 30 to squeeze the annular magnet 22 tighter as the hexagonal block 30 is inserted deeper in the polygonal hexagonal bore 18. Each of the bosses 38 is inserted in a corresponding one of the apertures 16.

The annular magnet 22 is firmly kept in the socket 10 by the lining 20 for several reasons. Firstly, the annular magnet 22 is tightly squeezed by the hexagonal block 30. Secondly, the ridges 36 are tightly pressed against the internal face of the section 14. Thirdly, the bosses 38 are firmly inserted in a corresponding one of the apertures 16.

Advantageously, the insertion of the ridges 36 in the grooves 13 facilitates precise positioning of the facets 34 relative to the facets 11. Moreover, the use of the ridges 36 does not compromise the strength of the lining 20 that would otherwise be compromised by cutouts, grooves or any other cutting.

A typical sparkplug 40 includes a connective end 42, a sparking end 44 opposite to the connective end 42, a hexagonal section 46 between the connective end 42 and the sparking end 44, and an annular flange 48 near the hexagonal section 46. To detach the sparkplug 40 from an engine for example, the connective end 42 of the sparkplug 40 is inserted into the hexagonal bore 18 of the socket 10 through the annular magnet 22. The hexagonal section 46 of the sparkplug 40 is inserted in the hexagonal bore 18 of the socket 10. The annular flange 48 of the sparkplug 40 is abutted against the section 14 of the socket 10 to stop further insertion of the connective end 42 of the sparkplug 40 into the hexagonal bore 18 of the socket 10. The hexagonal section 46 is in contact with the facets 11 so that the sparkplug 40 is rotatable with the socket 10. The annular magnet 22 attracts the hexagonal section 46 to retain the hexagonal section 46 in the hexagonal bore 18 of the socket 10.

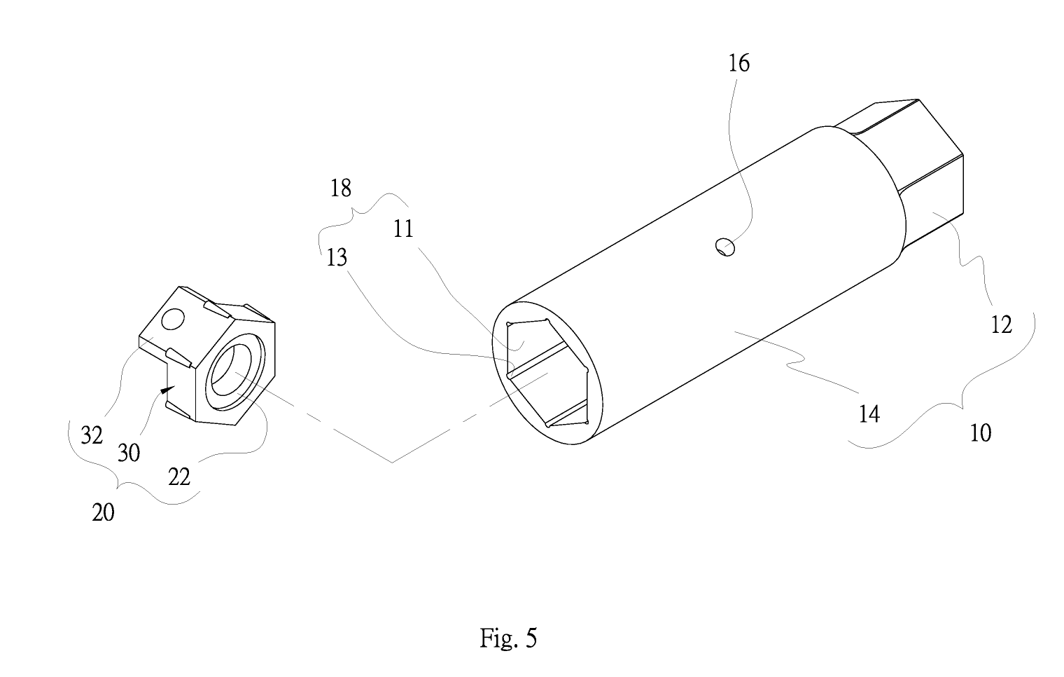

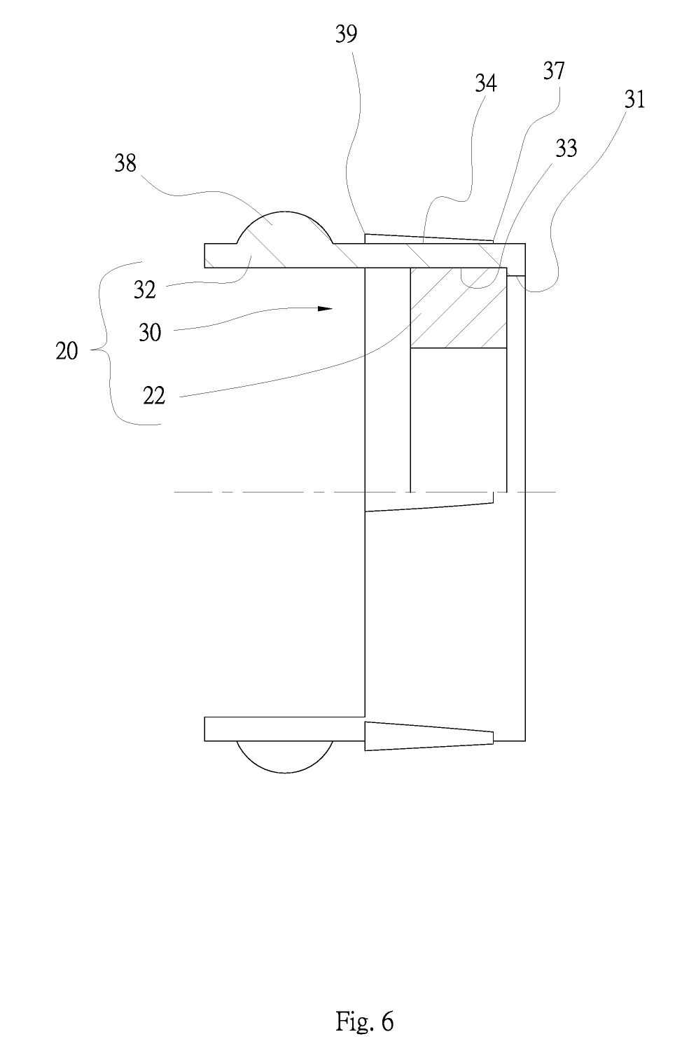

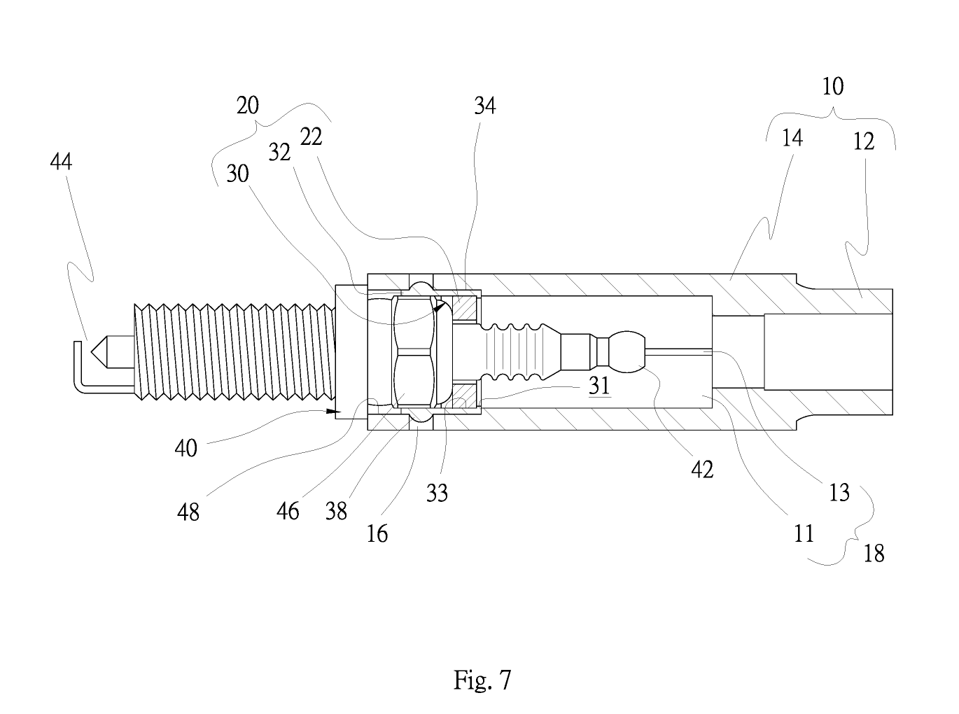

Referring to FIGS. 5 through 7, there is a socket assembly according to a second embodiment of the present invention. The second embodiment is identical to the first embodiment except that the strips 32 extend from a rear end of the hexagonal block 30. The hexagonal block 30 is inserted in the hexagonal bore 18 before the strips 32 instead of after so that the annular magnet 22 is deeper in the hexagonal bore 18. Hence, the annular magnet 22 is located near the connective end 42 of the sparkplug 40 instead of the hexagonal section 46 when the annular flange 48 of the sparkplug 40 is abutted against the section 14 of the socket 10. The annular magnet 22 attracts the connective end 42 of the sparkplug 40 instead of the hexagonal section 46.

The present invention has been described via the illustration of the embodiments. Those skilled in the art can derive variations from the embodiments without departing from the scope of the present invention. Therefore, the embodiments shall not limit the scope of the present invention defined in the claims.

1. A socket assembly comprising:
a socket comprising:
a hexagonal bore made therein;
six internal facets extending around the hexagonal bore; and
two apertures in communication with the hexagonal bore;
a lining comprising:
a hexagonal block inserted in the hexagonal bore and formed with a cavity, six external facets in contact with the internal facets of the socket, and six ridges each formed between two adjacent ones of the external facets;
two strips extending from the hexagonal block; and
two bosses each formed on a corresponding one of the strips and inserted in a corresponding one of the apertures; and
an annular magnet inserted in the cavity, wherein the annular magnet is squeezed tighter by the lining since the ridges are pressed tighter against an internal face of the socket as the lining is inserted deeper in the hexagonal bore.

2. The socket assembly according to claim 1, wherein the socket comprises a first section adapted for connection to a tool and a second section formed with the hexagonal bore, the facets and the apertures.

3. The socket assembly according to claim 2, wherein the first section comprises a square external face.

4. The socket assembly according to claim 2, wherein the first section comprises a square aperture.

5. The socket assembly according to claim 1, wherein each of the ridges comprises a front end and a rear end and rises higher from the hexagonal block in a radial manner while extending to the rear end from the front end, and the front end of each of the ridges is inserted in the hexagonal bore before the rear end.

6. The socket assembly according to claim 1, wherein the strips extend from a front end of the hexagonal block so that the strips are inserted in the hexagonal bore before the hexagonal block.

7. The socket assembly according to claim 1, wherein the strips extend from a rear end of the hexagonal block so that the strips are inserted in the hexagonal bore after the hexagonal block.

8. The socket assembly according to claim 1, wherein one of the strips comprises an external face in a same plane with one of the facets, and the other strip comprises an external face in a same plane with an opposite one of the facets.

9. The socket assembly according to claim 1, wherein the socket comprises six grooves each extending between two adjacent ones of the internal facets, and each of the ridges is inserted in a corresponding one of the grooves.
